(19) United States
(12) Patent Application Publication
(10) Pub. No.: US 2018/0340676 A1
(43) Pub. Date: Nov. 29, 2018

(54) OPTICAL COVER OF STRING LIGHTS

(71) Applicant: Chang-Fu TSAI, Taichung (TW)

(72) Inventor: Chang-Fu TSAI, Taichung (TW)

(21) Appl. No.: 15/607,376

(22) Filed: May 26, 2017

(51) Int. Cl. F21V 14/08; F21V 19/00; F21V 17/00; F21S 4/10; F21V 17/06; H01R 33/94

(52) U.S. Cl. CPC F21V 14/08; F21V 19/0035; F21V 19/0055; F21W 2121/00; F21S 4/10; F21V 17/06; H01R 33/94; F21V 17/002

(57) ABSTRACT

An optical cover is provided for combining with each lighting unit of a light string and includes a cover body and a mounting member. The cover body is provided on an external surface thereof with a sleeve, in which a through hole is formed for receiving and holding the lighting unit therein. The sleeve is provided with, on opposite sides thereof, with notches that receive extension of an electrical cable of the light string therethrough. The mounting member is mountable to the sleeve of the cover body to fix the lighting unit in the through hole and also fix the electrical cable in the notches. In this way, a user is allowed to select and arrange optical covers of different colors for respectively mounting to multiple lighting units of the light string.

### BACKGROUND OF THE INVENTION

### 1. Field of the Invention

The present invention relates to an optical cover of string lights, and more particularly to an optical cover that is selectively mountable to each lighting unit of string lights to change light color emitting from the lighting unit and dispersion and scattering of the light.

### 2. The Related Arts

String lights have been widely used in holiday celebrations, such as Christmas, and parties and festivals and light-emitting diodes (LEDs) are commonly used lighting units of the string lights. An example of string lights is illustrated in FIG. 2 and designated at 100, comprising an electrical cable 10 and a lighting unit 20 is mounted to each of multiple locations along the cable 10. The lighting unit 20 comprises a base 201 and an LED 202 mounted to the base 201. Upon being energized, the LEDs 202 of the lighting units 20 are activated to simultaneously emit light or, alternatively, the LEDs 202 may be controlled by a controller to flash and twinkle. However, the LEDs 202 of the multiple lighting units of the string 100 are often monochromatic LEDs. This would make the lighting decoration used in for example a festival or party monotonous and invariable. Further, light emission from the conventional LEDs is generally directional and is spot lighting, making it easy to result in undesired issues, such as light pollution.

In the technical field of string lights, a variety of light covers have been proposed and used to change the optical effect of the string lights, such as U.S. Pat. Nos. 5,685,635, 5,816,686, 6,343,870, 6,382,812, 6,514,105, and 7,241,032, in which a cover in the form of a sphere or other shapes is mounted to a lighting unit (which can be an LED or an incandescent bulb) of the light string to change light color and the effect of light dispersion and scattering. However, those known light covers for string lights are generally embodied such that they can only be mounted to the lighting units by the string lights manufacturers and the consumers are not allowed to select light covers of different colors and to arrange the colors of the light covers so selected for mounting to lighting units of a light string. Thus, it is desired to provide a light cover that allows the general consumer to assemble in a do-it-yourself (DIY) fashion for mounting the light cover to for example a lighting unit 20 of the light string 100 shown in FIG. 2 and this would helps overcome the shortcoming of the known light cover as discussed above. The present invention provides a solution that allows the consumers to easily and efficiently mount a light cover.

### SUMMARY OF THE INVENTION

The primary objective of the present invention is to provide an optical cover of string lights, which comprises a cover body and a mounting member that collectively make up the optical cover that can be embodied in multiple colors so that the consumers are allowed to select and mount the optical cover to each of multiple lighting units of a light string and thus achieving an effect of allowing a user to change the colors of the string lights and to make a desired color arrangement.

Another objective of the present invention is to provide an optical cover of string lights, in which a structural arrangement is provided, comprising a sleeve mounted to an external surface of the cover body and notches formed in opposite sides of the sleeve, to allow a lighting unit of the light string to be received into the sleeve and extending into the cover body, with an electrical cable of the light string received and held in the notches of the opposite sides of the sleeve so that the mounting member may close and seal the sleeve and the notches to thereby achieve an effect of allowing for easy and efficient assembling by a user.

A further objective of the present invention is to provide an optical cover of a light string, which provides a structural arrangement that allows for detachment of the mounting member and the sleeve of the cover body from each other so that a user is allowed to easily change and replace the optical cover.

A further objective of the present invention is to provide an optical cover of a light string, which provides multiple designs of an outside configuration of the cover body to allow a user to select and arrange multiple optical covers for the purposes of changing the overall configuration of the light string and the effect of light dispersion and scattering thereof.

### BRIEF DESCRIPTION OF THE DRAWINGS

The present invention can be fully understood from the following detailed description and preferred embodiments with reference to the accompanying drawings, in which:

FIG. 1 is a perspective view illustrating optical covers according to the present invention mounted to a light string;

FIG. 2 is an exploded view illustrating an optical cover of the present invention and the light string;

FIG. 3 is a perspective view showing a cover body of the optical cover of the present invention taken from a bottom side;

FIG. 4 is a cross-sectional view illustrating the optical cover of the present invention mounted to a lighting unit of the light string;

FIG. 5 is a schematic view illustrating an example of a spherical cover body of the optical cover according to the present invention in an assembled condition;

FIG. 6 is a schematic view illustrating an example of a spindle-shaped cover body of the optical cover according to the present invention in an assembled condition;

FIG. 7 is a schematic view illustrating an example of an ellipsoidal cover body of the optical cover according to the present invention in an assembled condition; and

FIG. 8 is a schematic view illustrating an example of a polyhedron cover body of the optical cover according to the present invention in an assembled condition.

### DETAILED DESCRIPTION OF THE PREFERRED EMBODIMENTS

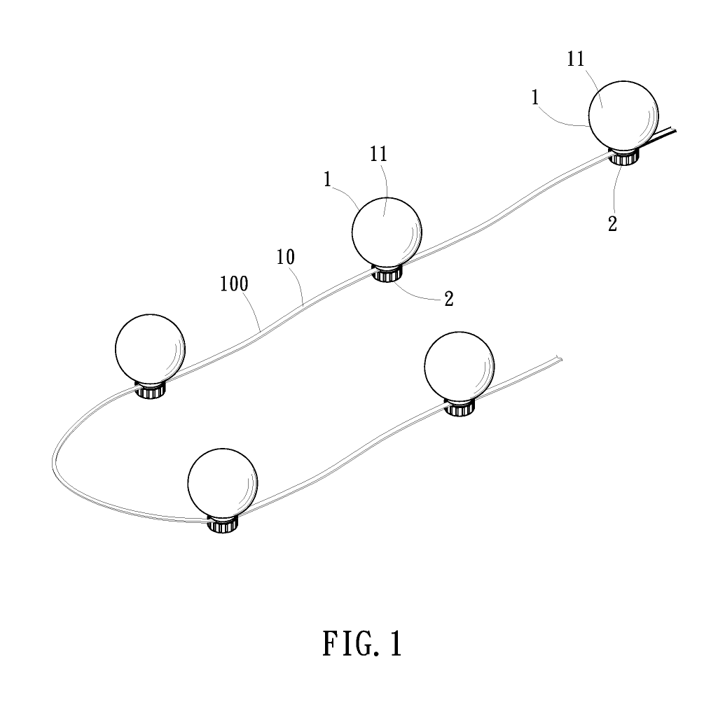

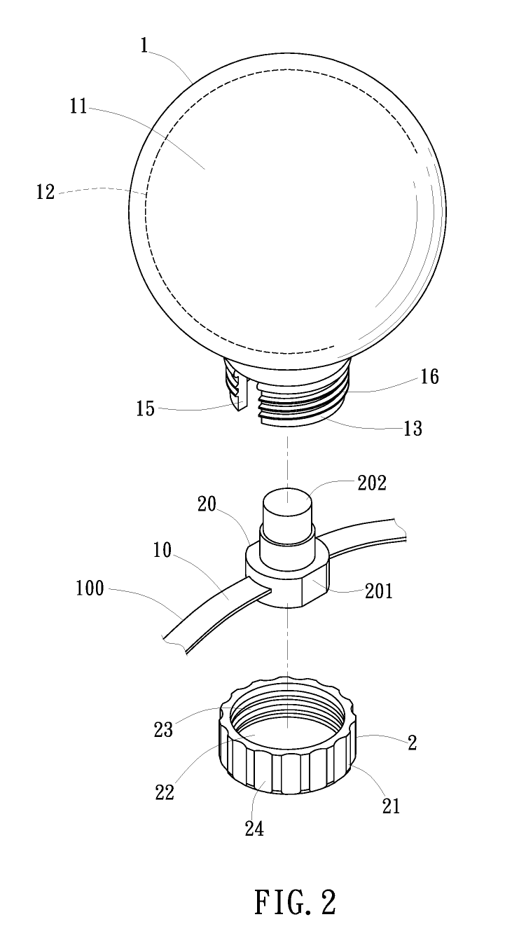

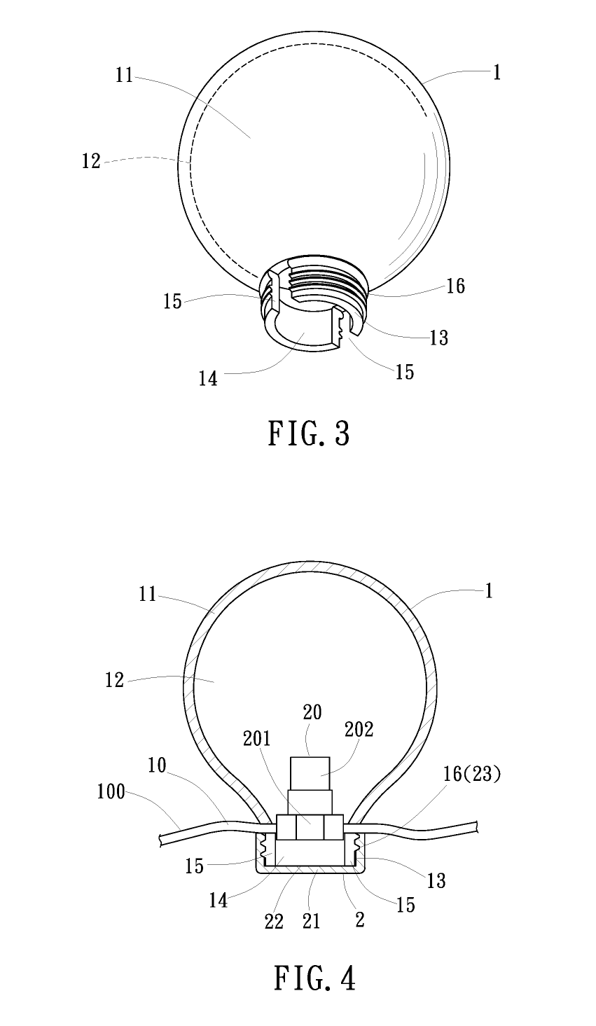

Referring to FIGS. 1 and 2, the present invention provides an optical cover for use with string lights and allowing a user to selectively mount the cover to each of multiple lighting units 20 that are attached to an electrical cable 10 of a light string 100 in order to change light color emitting from the lighting unit 20 and the effect of light dispersion and scattering of the lighting unit 20. Reference is now made to FIGS. 2, 3, and 4 in combination, a preferred embodiment of the present invention generally comprises a cover body 1, wherein the cover body 1 comprises a shell 11, an internal compartment 12 formed in an interior of the shell 11, a sleeve 13 mounted to an external surface of the shell 11, a through hole 14 extending from an end of the sleeve 13, completely through the sleeve, to reach into and communicate with the internal compartment 12 of the shell 11 for receiving and accommodating a lighting unit 20 therein, and two notches 15 formed in a circumferential wall of the sleeve 13 at opposite sides of the sleeve to receive extension of the electrical cable 10 of the light string 100 therethrough, the notches 15 being arranged to communicate between the outside of the sleeve 13 and the through hole 14; and a mounting member 2, wherein the mounting member 2 is combinable with the sleeve 13 so as to close and seal the sleeve 13 and the notches 15 and thus fix the lighting unit 20 in the through hole 14 of the cover body 1 and also to securely fix the electrical cable 10 in the notches 15.

Further referring to FIGS. 2 and 4, the mounting member 2 can be structured as an end cap 21 that is integrally formed as a unitary structure through injection molding of plastics such that the end cap 21 has an end face that is recessed to form a recess 22 for fitting over and combining with the sleeve 13. When the recess 22 of the end cap 21 is fit over the sleeve 13, the recess 22 is set over an external surface of the sleeve 13 in a removable (such as through screwing) or non-removable (such as jointing) manner so as to fix the lighting unit 20 in the through hole 14 and also fix the electrical cable 10 in the notches 15.

Further, in an embodiment, the recess 22 of the cap 21 is removably mounted to the sleeve 13, wherein an external thread 16 is formed on an outside surface of the sleeve 13 (as shown in FIGS. 2 and 4), and an internal thread 23 is formed on an inside surface of the recess 22 of the end cap 21, so that in mounting the end cap 21, a user may screw the internal thread 23 to the external thread 16 to carry out an assembling operation. Similarly, in another embodiment, the end cap 21 may be structured as a nut or may be replaced by a nut, which may be commercially available. Further, the end cap 21 may be provided, on an outside surface thereof, with an anti-skidding section 24, and the anti-skidding section 24 can be formed of multiple grooves arranged as elongates strips or knurled patterning to allow the user to easily twist or rotate the end cap 21.

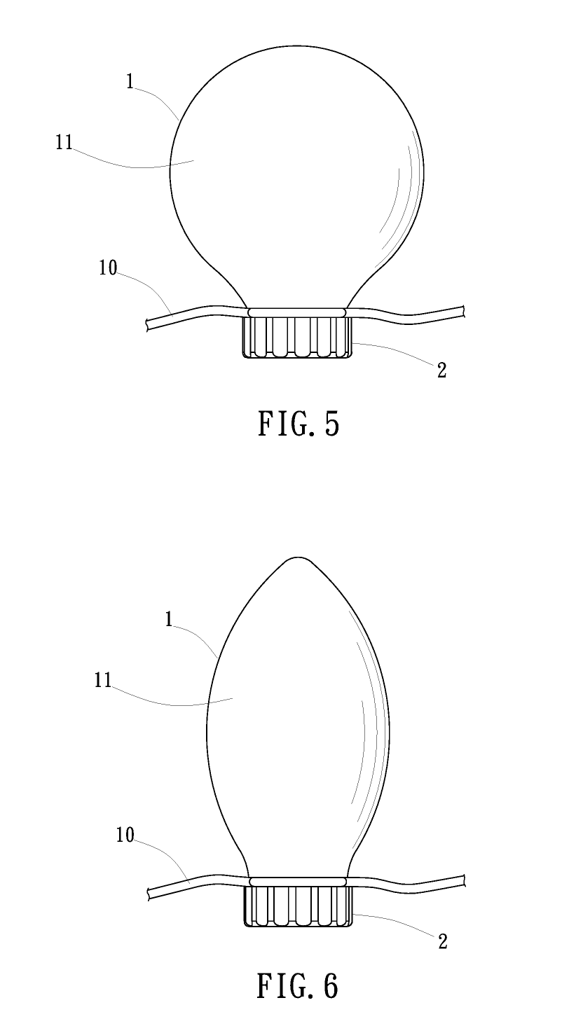

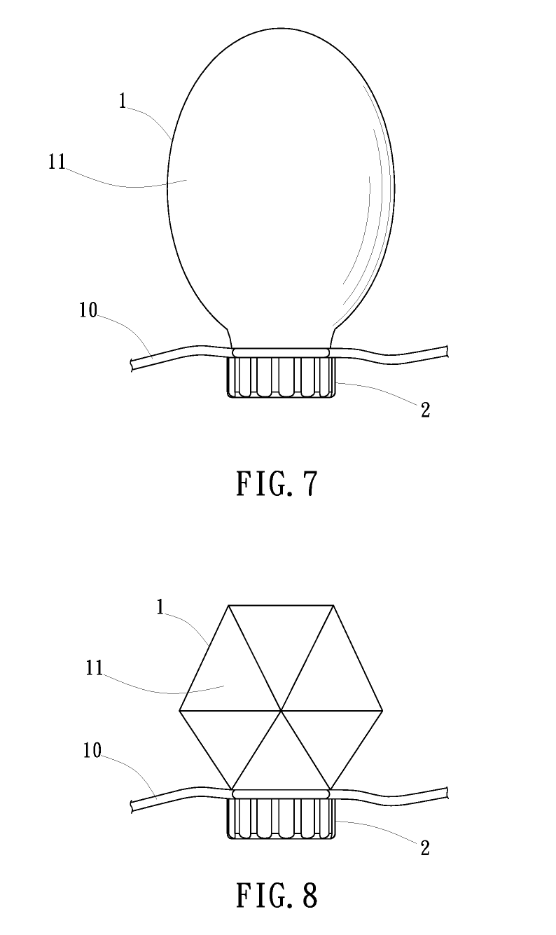

Referring to FIGS. 2, 3, and 4, in a preferred embodiment, the cover body 1 is structured such that the shell 11, the internal compartment 12, the sleeve 13, the through hole 14, the notches 15, and the external thread 16 as constituent components or parts or portions of the cover body are formed through injection molding of plastics in an integrally formed unitary structure, where the plastics are colored plastic materials such that the colors may be selected as desired so that users may select and purchase parts of desired colors for subsequent assembly to provide a light string of desired colors or color combinations. Further, the shell 11 of the cover body 1 may be made in the form of a sphere (as shown in FIGS. 2-5), a spindle (as shown in FIG. 6), an ellipsoid (as shown in FIG. 7), a polyhedron (as shown in FIG. 8), or any other desired shapes, and consequently the internal compartment 12 formed inside the shell 11 (as shown in FIG. 4) may be formed with a shape that corresponds to the shape of the shell 11 to provide different effects of dispersion and scattering of light.

Illustrated above are the embodiments of the present disclosure, which should not be considered limitative to the scope of the invention. Therefore, any equivalent substitutions or variations to the structures or processes disclosed in the specification and the drawing of the present disclosure, or a direct or indirect application of the invention to the other technical fields should be considered as part of the present disclosure.

1. An optical cover, which is adapted to mount to a lighting unit of a light string, comprising:
a cover body, which comprises a shell, an internal compartment formed in an interior of the shell, a sleeve mounted to an external surface of the shell, a through hole extending from an end of the sleeve, completely through the sleeve, to reach into and communicate with the internal compartment of the shell for receiving and accommodating the lighting unit therein, and two notches formed in opposite sides the sleeve to receive extension of an electrical cable of the light string therethrough, wherein the notches are arranged to communicate between the outside of the sleeve and the through hole; and
a mounting member, which is combinable with the sleeve of the cover body to fix the lighting unit in the through hole and to fix the electrical cable in the notches;
wherein the sleeve of the cover body has a distal end having an end surface distant from the shell, each of the two notches being formed in the end surface of the sleeve such that the notch comprises an opening formed in the end surface for receiving the electrical cable of the light string into the notch, the mounting member being combined with the sleeve to close the opening of the notch in the end surface of the sleeve so as to fix the electrical cable of the light string in the notch.

2. The optical cover as claimed in claim 1, wherein the mounting member comprise an end cap, which has an end face that is recessed to form a recess that is fit over and combined with the sleeve.

3. The optical cover as claimed in claim 2, wherein the recess of the end cap is fit to an outside surface of the sleeve in a removable or non-removable manner.

4. The optical cover as claimed in claim 3, wherein the outside surface of the sleeve comprises an external thread formed thereon and the recess of the end cap has an inside surface in which an internal thread is formed such that the internal thread is engageable with the external thread.

5. The optical cover as claimed in claim 4, wherein the end cap has an outside surface on which an anti-skidding section is formed.

6. The optical cover as claimed in claim 5, wherein the end cap is integrally formed through injection molding of plastics.

7. The optical cover as claimed in claim 1, wherein the cover body is formed through injection molding of a colored plastic material.

8. The optical cover as claimed in claim 1, wherein the shell has a configuration selected from one of a sphere, a spindle shape, an ellipsoid, and a polyhedron.

9. The optical cover as claimed in claim 8, wherein the internal compartment is shaped to correspond to the configuration of the shell.
